(19) United States
(12) Patent Application Publication
(10) Pub. No.: US 2010/0029260 A1
(43) Pub. Date: Feb. 4, 2010

(54) APPARATUS AND METHOD FOR RECOMMENDING A COMMUNICATION PARTY ACCORDING TO A USER CONTEXT USING A MOBILE STATION

(75) Inventors: Kwan-Lae Kim, Suwon-si (KR); Hae-Don Chon, Yongin-si (KR); Yun-Je Oh, Suwon-si (KR); Sung-Bae Cho, Seoul (KR); Jun-Ki Min, Yongin-si (KR)

Correspondence Address: THE FARRELL LAW FIRM, LLP, 290 Broadhollow Road, Suite 210E, Melville, NY, 11747, US

(73) Assignees: SAMSUNG ELECTRONICS CO., LTD., Suwon-si (KR); INDUSTRY-ACADEMIC COOPERATION FOUNDATION, YONSEI UNIVERSITY, Seoul (KR)

(21) Appl. No.: 12/533,578

(22) Filed: Jul. 31, 2009

(30) Foreign Application Priority Data
Jul. 31, 2008 (KR) 10-2008-0075151

(51) Int. Cl. H04M 3/00

(52) U.S. Cl. 455/418

(57) ABSTRACT

An apparatus and method for recommending a communication party according to a user context in an MS, in which log information received and stored in the MS is retrieved, current context information about the MS is estimated using the log information, similarities of all communication parties stored in a phonebook of the MS are calculated, and communication parties are recommended by comparing the similarities.

### PRIORITY

This application priority under 35 U.S.C. §119(a) to a Korean Patent Application filed in the Korean Intellectual Property Office on Jul. 31, 2008 and assigned Serial No. 10-2008-0075151, the entire disclosure of which is incorporated herein by reference.

### BACKGROUND OF THE INVENTION

1. Field of the Invention

The present invention relates generally to recommending a communication party in a Mobile Station (MS). More particularly, the present invention relates to an apparatus and method for analyzing a current context of a user based on personal information, schedule information, and a call pattern of the user stored in an MS and recommending a communication party list according to the current user context.

2. Description of the Related Art

Commonly, individuals communicate with multiple persons and organizations in their daily lives. Accordingly, people generally must store a large number of phone numbers and/or contact information. For example, an MS includes a contact directory, which was conventionally a name and an associated telephone number, in addition to a voice call function. However, over time, the significance of the directory has increased as a tool for human network management, because it can be used to store additional information, e.g., home and email addresses, in addition to phone numbers.

Further, the initial MSs could only store the names and phone numbers of about 100 communication parties in a built-in directory or phonebook. However, because of the various innovations in data storage and miniaturization of memory devices, MSs are now capable of storing, for example, 5,000 to 10,000 phone numbers, addresses, notes, etc.

When a user searches for a phone number in such a directory, the search is done sequentially through a total list, by name, or by phone number, without regard to a current context of the user. Considering that people today manage more than one hundred phone numbers, a search of these managed communication parties with a same priority is often very inefficient.

In order to improve upon this inefficiency, various methods for searching for a phone number list have been created, such as a method for outputting a list of communication parties with high priority levels based on a past call pattern of an MS or a method for searching for phone numbers using a phone number group associated with a current location of the MS. While these methods conveniently relieve the user of many of the inconveniences of the conventional phone number searches, because the search is done without serious consideration of a complex situation of the user, the accuracy of communication party recommendation is still often low.

### SUMMARY OF THE INVENTION

Accordingly, the present invention has been designed to address at least the problems and/or disadvantages described above, and to provide at least the advantages described below. An aspect of the embodiments of the present invention is to provide an apparatus and method for providing an appropriate list of communication parties by configuring user context information through integration of a plurality of types of user information stored in an MS.

In accordance with an aspect of the embodiments of the present invention, a method is provided for recommending a communication party according to a user context in an MS, in which log information received and stored in the MS is retrieved, current context information about the MS is estimated using the log information, similarities of all communication parties stored in a phonebook of the MS are calculated, and communication parties are recommended by comparing the similarities.

In accordance with another aspect of the embodiments of the present invention, an apparatus is provided for recommending a communication party according to a user context in an MS, in which a phonebook generates an ID of a communication party and stores a phone number and necessary information for the ID, a memory stores received information distinguishably, a log information portion acquires location information about the MS, time information, and received personal information management system information and stores the acquired information in the memory, a context information estimator estimates context information about the MS using the acquired information, and a controller analyzes the acquired information of the log information portion and prioritizes communication parties with high communication probabilities by analyzing the estimated context information.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram of an MS for recommending communication parties using user log information and user context information according to an embodiment of the present invention;

FIG. 2 is a diagram illustrating a relationship between information used to estimate an emotion state and information represented as a Bayesian network according to an embodiment of the present invention;

FIG. 3 is a diagram illustrating a relationship between information used to estimate a busy state and information represented as a Bayesian network according to an embodiment of the present invention;

FIG. 4 is a diagram illustrating a relationship between information used to estimate amity toward another party and information represented as a Bayesian network according to an embodiment of the present invention;

FIG. 5 is a flowchart illustrating an operation for recommending a communication party using log information and estimated information according to an embodiment of the present invention; and

FIG. 6 is a table listing recommended communication parties on a display of an MS according to an embodiment of the present invention.

### DETAILED DESCRIPTION OF EMBODIMENTS OF THE INVENTION

The matters defined in the following description such as detailed constructions and elements are provided to assist in a comprehensive understanding of the embodiments of the present invention. Accordingly, those of ordinary skill in the art will recognize that various changes and modifications of the embodiments described herein can be made without departing from the scope and spirit of the present invention. Also, descriptions of well-known functions and constructions are omitted for clarity and conciseness.

Conventionally, communication parties are recommended from a phonebook based on time information or location information, without full consideration of the situation of a user. Therefore, the accuracy of the communication party recommendation is low.

Accordingly, the present invention provides an apparatus and method for collecting log information about communication parties, estimating context information using the log information for the communication parties, and recommending communication parties according to priority levels of the context information.

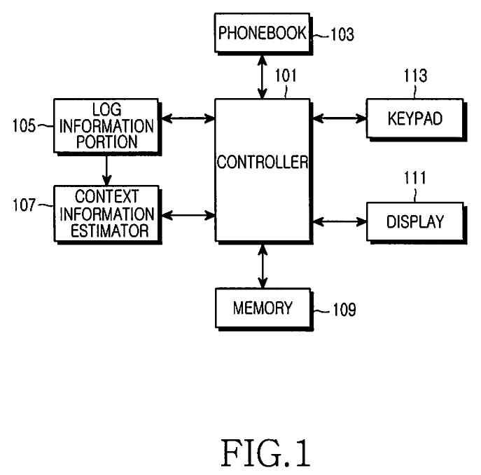

FIG. 1 is a block diagram of an MS for recommending communication parties using user log information and user context information according to an embodiment of the present invention.

Referring to FIG. 1, the MS includes a memory 109, a log information portion 105, a context information estimator 107, a keypad 113, a display 111, a phonebook 103, and a controller 101. The phonebook 103 generates an Identifier (ID) for each communication party such that a phone number and necessary information are entered for the ID. The ID of a communication party may be the name of the communication party, or a text or a symbol representing the communication party. When updating or searching for the IDs of communication parties by the controller 101, the phonebook 103 outputs the results in a predetermined order.

The memory 109 writes and stores data in an allocated area according to a command received from the controller 101. The keypad 113 provides various data including the phone numbers of communication parties to the memory 109.

The log information portion 105 stores log information about a Base Station (BS) to which the MS belongs, Global Positioning System/Local Positioning System (GPS/LPS) information, time information, day information, Bluetooth reception information, personal information management system information, call information, short message information, etc. The current location of the user and the current time may be acquired based on the above information.

Table 1 lists various types of log entries in the log information portion 105 and their descriptions, by way of example.

TABLE 1

| Log type | Description |
|---|---|
| BS, GPS, LPS | User location |
| Time information, day information | User time |
| Bluetooth reception information | List of communication parties that |
| | user met |
| Personal information management | User schedule |
| system information | |
| Call log, short message log | User call pattern |

Referring to Table 1, BS information and GPS/LPS indicate the location of the MS. Thus, the current location of the user is detected based on the BS information and GPS/LPS. Bluetooth reception information indicates the presence or absence of Bluetooth-enabled MSs around the user. If the ID of the user is registered in the MS, information about when and how long the user previously got in touch with a specific communication party may be acquired. Also, necessary data such as schedule information and anniversary information about the user may be checked in real time from personal information management system information. Call and short message logs may be used for checking a call pattern of the user.

The context information estimator 107 estimates an emotion state, a busy state, and an amity feeling of the user using a Bayesian network representing probability dependency between information acquired by the log information portion 105.

In accordance with an embodiment of the present invention, the structure and probability value of the Bayesian network are set and various applications may be made by contracting or extending the network structure through a change of the set values or by changing state values of user information.

The controller 101 analyzes all information received from the log information portion 105, analyzes context information that the context information estimator 107 estimated based on the information received from the log information portion 105, prioritizes communication parties with high use probabilities, and displays the communication parties on the display 111. The priority levels of the communication parties may be set in a limited manner according to situations. The display 111 displays phone numbers or intended data on an output device of the MS.

A detailed description will be now be provided for a method of recommending appropriate communication parties using log information stored in the log information portion 105 and the context information estimated by the context information estimator 107.

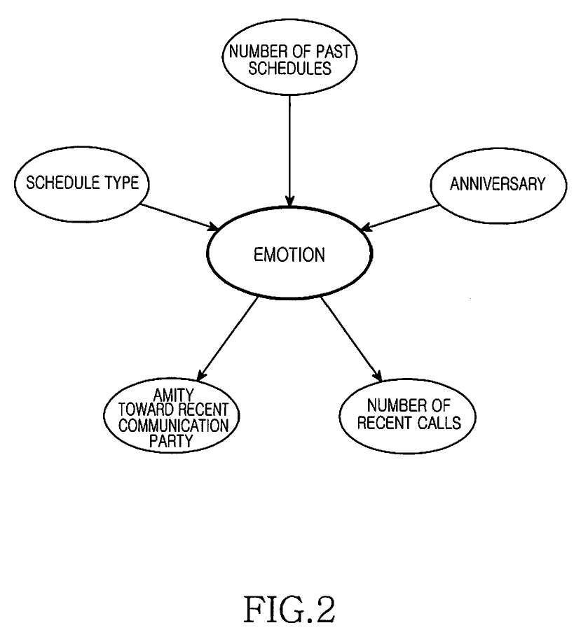

FIG. 2 is a diagram illustrating a relationship between information used to estimate an emotion state and information represented as a Bayesian network according to an embodiment of the present invention. In FIG. 2, four emotion states, “happy”, “angry”, “sad”, and “comfortable” are defined in accordance with an embodiment of the present invention. However, various emotion states may be defined by contracting or extending the Bayesian network or by changing state values of user information.

Referring to FIG. 2, an emotion state may be estimated using, for example, five pieces of log information stored in the log information portion and the Bayesian network. The five pieces of log information are schedule type, the number of past schedules, anniversary, amity, and a number of recent calls, as listed in Table 2 below.

TABLE 2

| Log | State | Description |
|---|---|---|
| Schedule type | Business/ | Official “Business” or |
| | Appointment | personal “Appointment” |
| Number of past | Many/Few | For two or more schedules during |
| schedules | | one day, “Many” |
| Anniversary | Yes/No | Today is anniversary or not |
| Amity | High/Low | Determined by Bayesian network |
| Number of recent | Many/Few | For five or more calls during |
| calls | | previous time period, “Many” |

The Bayesian network for estimating an emotion state may be built using the five pieces of log information listed in Table 2. The Bayesian network may estimate the emotion state according to preset state values. For example, if the log information indicates that today is an anniversary and there are two or less schedules for one day, the emotion state is assumed to be happiness and thus set to as “happy”.

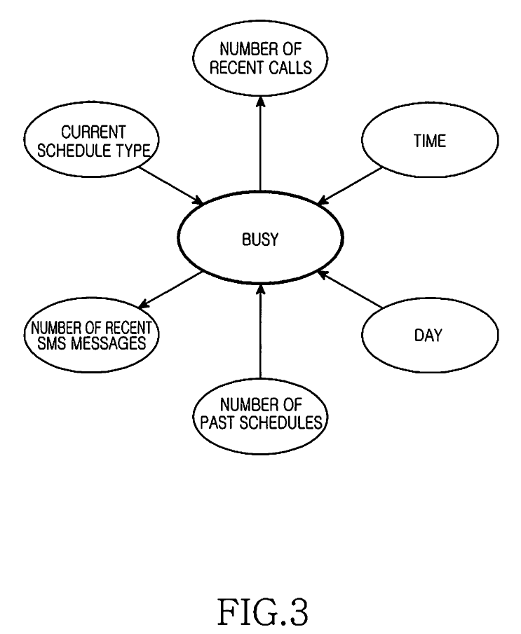

FIG. 3 is a diagram illustrating a relationship between information used to estimate a busy state and information represented as a Bayesian network according to an embodiment of the present invention. In FIG. 3, two busy states are defined, “busy” and “free”. However, various busy states may also be defined by contracting or extending the Bayesian network and changing state values of user information.

Referring to FIG. 3, a busy state may be estimated using, for example, six pieces of log information stored in the log information portion and the Bayesian network. The six pieces of log information are schedule type, the number of past schedules, time, day, the number of recent calls, and the number of recent short messages, as listed in Table 3 below.

TABLE 3

| Log | State | Description |
|---|---|---|
| Schedule type | Business/ | Official “Business” or personal |
| | Appointment | “Appointment” |
| Number of past | Many/Few | For two or more schedules during |
| schedules | | one day, ‘Many’ |
| Time | Morning | Morning: 6 to 12 |
| | Afternoon | Afternoon: 12 to 18 |
| | Evening | Evening: 18 to 24 |
| | Night | Night: 24 to 6 |
| Day | Beginning of the | Beginning of the week: Monday, |
| | week | Tuesday |
| | Middle of the | Middle of the week: Wednesday, |
| | week | Tursday, Friday |
| | Weekend | Weekend: Saturday, Sunday |
| Number of recent | Many/Few | For five or more calls during |
| calls | | previous time period, ‘Many’ |
| Number of recent | Many/Few | For five or more short messages |
| short messages | | during previous time period, |
| (SMS messages) | | “Many” |

The Bayesian network for estimating a busy state may be built using the six pieces of log information listed in Table 3. The Bayesian network may estimate the busy state according to preset state values. For example, when “busy” is set for 10 calls and 15 or more short messages, Thursday afternoon is “busy” when 20 calls are made and there are 17 short messages during the time period between 1 pm and 2 pm on Thursday. As described above, the busy states may vary depending on preset values.

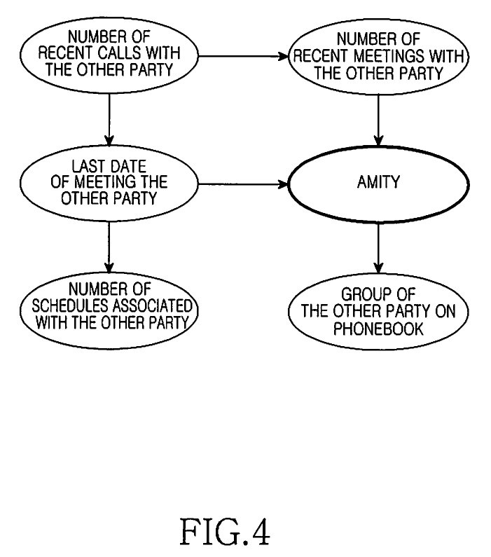

FIG. 4 is a diagram illustrating a relationship between information used to estimate amity toward another party and information represented as a Bayesian network according to an embodiment of the present invention. In FIG. 4, two amity levels are defined, “high” and “low”. However, various amity levels may also be defined by contracting or extending the Bayesian network or by changing state values of user information.

Referring to FIG. 4, amity may be estimated using, for example, five pieces of log information stored in the log information portion and the Bayesian network. The five pieces of log information are the number of recent calls with the other party, the latest date of meeting the other party, the number of recent meetings with the other party, the number of schedules associated with the other party, and a phonebook group of the other party, as listed in Table 4.

TABLE 4

| Log | State | Description |
|---|---|---|
| Number of recent | Many/Few | For five or more calls with |
| calls with the | | particular communication party |
| other party | | during one week, “Many” |
| Latest date of | Recent/Long ago | If the last day of meeting |
| meeting the other | | particular communication party is |
| party | | within one week, “Recent” |
| Number of | Many/Few | For two or more meetings with |
| meetings with the | | particular communication party |
| other party | | during previous week, “Many” |
| Number of | Many/Few | For two or more schedules |
| schedules | | associated with particular |
| associated with | | communication party during |
| the other party, | | previous week, “Many” |
| Phonebook group | Talk | Talk: on business terms |
| of the other party | Play | Play: friend |
| | Love | Love: lover, family |

The Bayesian network for estimating amity may be built using the five pieces of log information listed in Table 4. The Bayesian network may estimate amity toward the other party according to preset state values.

A context vector may be generated using the emotion state, busy state, and amity estimated using the pre-stored log information and the Bayesian networks. In accordance with an embodiment of the present invention, the context vector includes a current location, a current day, a current time, a nearby party among parties registered in the phonebook, a current schedule, a current emotion state, a busy state, and an amity level. Communication parties that are highly probable to communicate with the user may be extracted based on the context vector as illustrated in Table 5.

TABLE 5
Context = {Location, Time(Day), Time(Hour), Nearby, Schedule,
Emotion, Busy, Amity(A)}
Location: current location or location at the time when a call is created
Time(Day): current day or day when a call is created (e.g., Mon, Tues,
Wed, Thurs, Fri, Sat, Sun)
Time(Hour): current time or time when a call is created (e.g., morning,
afternoon, evening, night)
Nearby: current close communication party or close communication party
when a call is created, among communication parties registered in the
phonebook
Schedule: current schedule or schedule when a call is created (e.g.,
categories of class, appointment, etc.)
Emotion: current user emotion or user emotion when a call is created
Busy: current user busy level or user busy level when a call is created
Amity(A): current user amity toward the other party A or user amity
toward the other party A when a call is created

In Table 5, “Context” represents the context vector. For “Nearby” or “Schedule”, there may be no nearby party or schedule depending on the situation of the user. In this case, the value of “Nearby” or “Schedule” is “None”.

To determine the communication context of the user with respect to a communication party, a context information score and a context information priority are defined in addition to the context vector. The context information score is obtained by dividing the number of occurrences of log information L in a call log about a specific communication party by the total number of calls with the communication party. The context information priority is the standard deviation of the context information score. For example, if a user made five calls with another party A, of which three calls were made when the user was in Santa Clara and of which three calls were made when the user was in Cupertino, the number of occurrences of log information L (Santa Clara) is 3 and the number of occurrences of log information L (Cupertino) is 2. Besides location, any other log information such as time, emotion, or the like may be used as the log information L.

In accordance with an embodiment of the present invention, context information scores and context information priority levels of a communication party are computed for each context by mapping context information accumulated in the MS to call information in each context. As the user conducts more calls, the context information scores and context information priority levels increase and are updated automatically. Thus, various contexts of the user may be modeled and similarity among them may be computed as shown in Equation (1).

Call probability of communication party A={context information score A(Location)*context information priority A(Location)}+{context information score A(Day)*context information priority A(Day)}+{context information score A(Hour)*context information priority A(Hour)}+{context information score A(Nearby)*context information priority A(Nearby)}+{context information score A(Schedule)*context information priority A(Schedule)}+{context information score A(Emotion)*context information priority A(Emotion)}+{context information score A(Busy)*context information priority A(Busy)}+{context information score A(Amity)*context information priority A(Amity)} (1)

As can be noted from Equation (1), the probability of calling the communication party A by the user may be computed using a context vector, context information scores, and context information priority levels. Thus, the similarity between the context information of a previous call and the current context information may be computed. A final communication party may be recommended from among communication parties registered in the phonebook of the user, using the similarity. An operation for computing the probability of a communication party being called in accordance with the similarity will be described below.

For better understanding of the operation, five recent calls with a communication party are taken as an example. The elements of a context vector are illustrated in Table 5 and the context vectors of the recent five calls and the current context vector with respect to the communication party A are listed in Table 6 below.

TABLE 6
Contexts of recent five calls with communication party A
1. Context = {Santa Clara, Mon, Morning, {B}, none, angry, busy, high}
2. Context = { Santa Clara, Tues, Morning, none, class, comfortable,
free, high}
3. Context = {Cupertino, Thurs, afternoon, {C}, appointment,
comfortable, busy, low}
4. Context = {Santa Clara, Mon, morning, {B, D}, none, angry, busy,
high}
5. Context = {San Jose, Tues, evening, none, none, happy, free, high}
Current user context
Context = {Santa Clara, Wed, morning, {B}, none, sad, free, high}

The context information scores of the communication party are computed using the five recent context vectors and the current user vector, as shown in table 7.

TABLE 7

| location | date | time | nearby | schedule | emotion | busy | Amity |
|---|---|---|---|---|---|---|---|
| Santa | Mon = 0.4 | morning = | B = 0.4 | class = 0.2 | angry = 0.4 | busy = | high = 0.8 |
| Clara = 0.6 | | 0.6 | | | | 0.6 | |
| Cupertino = 0.2 | Tues = 0.4 | afternoon = | C = 0.2 | appointment = | comfortable = | free = 0.4 | Low = |
| | | 0.2 | | 0.2 | 0.4 | | 0.2 |
| San Jose = 0.2 | Thurs = | evening = 0.2 | D = 0.2 | none = 0.6 | sad = 0.2 | | |
| | 0.2 | | | | | | |
| | | | none = | | | | |
| | | | 0.2 | | | | |

As described above, each context information score listed in Table 7 is calculated by dividing the number of occurrences of log information L in a call log associated with the communication party A by the total number of calls with the communication party A. The context information priority levels of the communication party A are calculated using the context information scores, as shown in Table 8.

TABLE 8

| location | date | time | nearby | schedule | emotion | busy | amity |
|---|---|---|---|---|---|---|---|
| 0.2 | 0.1 | 0.2 | 0.1 | 0.2 | 0.1 | 0.1 | 0.4 |

As described above, the context information priority levels listed in Table 8 are the standard deviations of the context information scores. Then the probability of the user calling the communication party is computed to be 0.64 (=0.6×0.2+0×0.1+0.6×0.2+0.4×0.1+0×0.2+0×0.1+0.4×0.1+0.8×0.4) by applying the context information scores and the context information priority levels to Equation (1). 0.64 is the probability of the user calling the communication party A or the similarity between the previous context information and the current context information. Similarity is calculated for every communication party registered in the phonebook and a communication party with the highest similarity is recommended to the user.

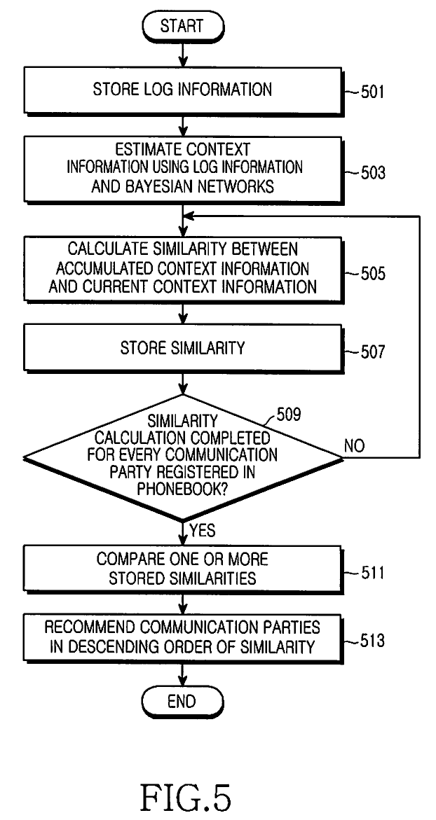

FIG. 5 is a flowchart illustrating an operation for recommending a communication party using log information and estimated information according to an embodiment of the present invention.

Referring to FIG. 5, the MS collects and stores one or more pieces of received log information in a storage such as a memory in step 501. The log information is largely divided into location information such as BS information or GPS information, and location information such as call information or day information. In step 503, the context information of the user is estimated using one or more pieces of collected log information and Bayesian networks. Previous context information has been stored in the storage. In accordance with an embodiment of the present invention, the user context information involves emotion, busy state, and amity, which may be changed during an initial selection.

In step 505, the MS calculates a similarity between the previous context information that has been accumulated and the current context information for each communication party, using the context information scores and context information priority levels of the communication party. The similarities are stored in the storage in step 507.

The MS determines whether a similarity has been calculated for every communication party registered in the phonebook in step 509. If the similarity calculation is still going on, steps 505 and 507 are repeated until the similarities are computed for all communication parties. Upon completion of the similarity calculation, the stored similarities are compared and the communication parties are arranged in a descending order of similarity in step 511.

In step 513, a list of arranged communication parties is made according to a user preference and output on the display. The communication parties may be displayed sequentially in a descending order of similarity or only a list of a predetermined proportion of the arranged communication parties may be displayed, on the display.

As described above, optimal communication parties may be recommended according to a statistic rule based on log information and context information of a user. The phone numbers of desired communication parties may be readily accessed, and upon selection of communication parties to be recommended, they are displayed on the display.

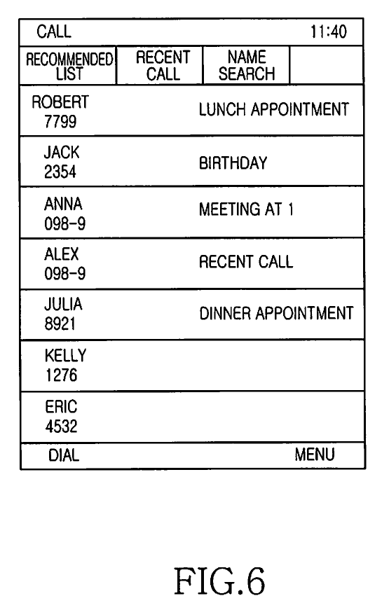

FIG. 6 is a table listing recommended communication parties on the display of an MS according to an embodiment of the present invention.

Referring to FIG. 6, names of recommended communication parties as their IDs are displayed along with reasons for recommending them. The recommendation reasons may be preset or part of log information used for context information. Thus, the user readily recognizes the purposes of calls with the recommended communication parties.

Communication parties may be displayed in a descending order of similarity as illustrated in FIG. 6, or a group of communication parties with a highest sum or average of similarities may be displayed.

As is apparent from the above description, context information is estimated using log information including information about the location of a user, time information, information about the behavior of the user, etc., and communication parties are recommended using the context information according to a statistic rule. Therefore, the phone numbers of intended communication parties are readily accessible to the user.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A method for recommending a communication party according to a user context in a Mobile Station (MS) including a memory, a context information estimator, and a controller, the method comprising:
retrieving log information from the memory of the MS;
estimating, by the context information estimator, current context information about the MS using the retrieved log information;
calculating, by the controller, similarities of all communication parties stored in a phonebook of the MS based on the current context information; and
recommending, by the controller, communication parties by comparing the calculated similarities.

2. The method of claim 1, wherein the log information includes location information and time information that is acquired when the MS communicates with the communication parties.

3. The method of claim 1, wherein estimating the current context information comprises:
estimating the current context information using the retrieved log information and a Bayesian network with a preset structure and probability value,
wherein the current context information includes information about at least one of an emotion state, a busy state, and an amity level.

4. The method of claim 1, wherein calculating the similarities of all the communication parties comprises:
calculating, for each communication party, a similarity between the current context information and context information about communication with each communication party stored in the phonebook of the MS.

5. The method of claim 4, wherein calculating the similarities of all the communication parties comprises:
mapping context information about communication with each communication party to call information;
calculating a context information score and a context information priority level of each communication party; and
calculating the similarity for each communication party using the context information score and the context information priority level.

6. The method of claim 5, wherein calculating the context information score comprises:
dividing a number of occurrences of log information about the communication party by the number of communications with the communication party in a call log of the communication party, and
wherein calculating the context information priority level of each communication party comprises:
calculating a standard deviation of the context information score.

7. The method of claim 1, wherein recommending the communication parties comprises:
displaying the recommended communication parties on a display of the MS according to a predetermined method; and
displaying recommendation reasons for the communication parties.

8. The method of claim 7, wherein the recommendation reasons include information stored by a user of the MS or at least one piece of log information used for the similarity calculation.

9. A Mobile Station (MS) apparatus for recommending a communication party according to a user context, the apparatus comprising:
a phonebook for generating an Identifier (ID) of a communication party and storing a phone number and necessary information for the ID;
a log information portion for acquiring location information about the MS, time information, and received personal information management system information and storing the acquired information in a memory;
a context information estimator for estimating context information about the MS using the acquired information; and
a controller for prioritizing communication parties with high communication probabilities by analyzing the estimated context information.

10. The apparatus of claim 9, wherein the location information comprises base station information and satellite communication information.

11. The apparatus of claim 9, wherein the time information comprises call information, short message information, and short-range communication information.

12. The apparatus of claim 9, wherein the personal information management system information comprises schedule information and anniversary information.

13. The apparatus of claim 9, wherein the context information estimator estimates the context information using a Bayesian network representing probability dependency among the acquired information of the log information portion, the context information including information about at least one of an emotion state, a busy state, and an amity level.
